(19) United States
(12) Patent Application Publication
(10) Pub. No.: US 2018/0250780 A1
(43) Pub. Date: Sep. 6, 2018

(54) Assembly and/or processing machine, production line formed thereby and production plant

(71) Applicant: Schaeffler Technologies AG & Co. KG, Herzogenaurach (DE)

(72) Inventors: Detlef Scholtz, Hassfurt (DE); Martin Lutz, Untertheres (DE); Benno Sterzinger, Rödelmaier (DE); Wolfgang Schnabel, Shanghai (DE); Thomas Thomas Schmitt, Schalkau (DE)

(73) Assignee: Schaeffler Technologies AG & Co. KG, Herzogenaurach (DE)

(21) Appl. No.: 15/750,233

(22) PCT Filed: Aug. 4, 2016
(86) PCT No.: PCT/DE2016/200359

§ 371 Date: Feb. 5, 2018

(30) Foreign Application Priority Data
Aug. 17, 2015 (DE) 10 2015 215 625.7

(51) Int. Cl. B23Q 7/14; B23P 21/00; B23Q 7/03; B23Q 11/08; B23Q 37/00; B23Q 41/04

(52) U.S. Cl. CPC B23Q 7/1405; B23P 21/004; B23Q 7/03; B23Q 1/0045; B23Q 37/007; B23Q 41/04; B23Q 11/0891

(57) ABSTRACT

Machines, such as assembly and/or processing machines are disclosed. The machine may include a working chamber for assembling and/or processing of a component and a transport device configured to transport the component into the working chamber. A moveable housing may be configured to temporarily shield the working chamber during the assembly and/or processing of the component in the working chamber. The housing may include a viewing window which, when the housing is closed, allows observation of the assembly and/or processing of the component in the working chamber. An operating and display unit may be arranged on a movable part of the housing and is movable together therewith.

### CROSS-REFERENCE TO RELATED APPLICATIONS

This application is the U.S. National Phase of PCT Appln. No. PCT/DE2016/200359 filed Aug. 4, 2016, which claims priority to DE 102015215625.7 filed Aug. 17, 2015, the entire disclosures of which are incorporated by reference herein.

### TECHNICAL FIELD

The disclosure relates to an assembly and/or processing machine, comprising a working chamber for the assembly and/or processing of at least one component, at least one transport device for transporting the at least one component into the working chamber, a protective housing which is at least partially movable and which serves for temporarily shielding the working chamber during the assembly and/or processing of the at least one component in the working chamber, wherein the protective housing comprises at least one viewing window which, when the protective housing is closed, makes it possible to observe the assembly and/or processing of the at least one component in the working chamber, and at least one operating and display unit.

### BACKGROUND

Such assembly and/or processing machines are known. For example, DE 202012001579 U1 presents a processing machine in the form of a cleaning installation for shafts, in the case of which an operating panel fastened to a movable arm serves as control unit. A manually controlled handling system is described as a transport device for introducing the component to be cleaned or processed.

Furthermore, assembly and/or processing machines are also known in the case of which separate side cabinets or units are provided into which operating and display units for the assembly and/or processing machine are integrated.

In order for a component to be fed to different assembly and/or processing machines in succession, it is increasingly the case that said assembly and/or processing machines are linked together. Here, such linking-together commonly encompasses a situation in which transport devices feed the component to the different assembly and/or processing machines in succession, wherein, with regard to the time required for the transport and the space requirement of the assembly and/or processing machines linked together to form a production line, as compact an arrangement as possible is preferred. Here, the assembly and/or processing machines are arranged spatially as close together as possible, and thus the transport paths are kept short. Here, the known operating and display units often prove to be disruptive, because they either have their own space requirement or, in the case of the assembly and/or processing machines being linked together, they prove to be difficult to integrate into the overall concept of a production line.

### SUMMARY

It is therefore an object of the disclosure to provide an assembly and/or processing machine having an operating and display unit, which can be integrated in an optimum manner into a production line. It is furthermore an object of the disclosure to specify a production line and a production installation having such assembly and/or processing machines and having a reduced space requirement.

For the assembly and/or processing machine, comprising a working chamber for the assembly and/or processing of at least one component, at least one transport device for transporting the at least one component into the working chamber, a protective housing which is at least partially movable and which serves for temporarily shielding the working chamber during the assembly and/or processing of the at least one component in the working chamber, wherein the protective housing comprises at least one viewing window which, when the protective housing is closed, makes it possible to observe the assembly and/or processing of the at least one component in the working chamber, and at least one operating and display unit, the object is achieved in that the at least one operating and display unit is arranged on a movable part of the protective housing and is movable together therewith.

Such an arrangement of an operating and display unit is particularly advantageous because said operating and display unit does not require its own space and does not pose an obstruction in the linking-together of multiple assembly and/or processing machines. Here, an integration of the operating and display unit into the protective housing, in particular into a movable part of the protective housing, is not trivial, because the operating and display unit must move together with the movable part, and at the same time the full functionality of the protective housing, which ensures the safety of the operating personnel, and also of the operating and display unit must be ensured during continuous operation.

Here, it may be preferable if the at least one operating and display unit is fully functional not only when the protective housing is closed but also when the protective housing is open. This makes it easier to perform installation and setup work, and also maintenance and repair work. A high level of flexibility of the assembly and/or processing machine is realized, whereby even small batch sizes can be produced economically.

In particular, the movable part of the protective housing, on which the operating and display unit is arranged, may be pivotable and/or displaceable. Such a pivoting, displacement or displacement and pivoting movement can be realized in a particularly space-saving manner.

If the assembly and/or processing machine is a processing machine, it is preferably designed to perform deformation, cutting, joining, coating or material alteration on the component. Washing, dust removal, demagnetization and the like are however also to be regarded in the context of the present disclosure as processing of the at least one component.

Here, the processing machine preferably comprises at least one of the following units: a grinding machine, a honing machine, a milling machine, a turning machine, a lapping machine, a drilling machine, a punching unit, a press unit, a heat treatment unit, a cleaning unit, a drying unit, a demagnetization unit.

An assembly and/or processing machine preferably furthermore comprises at least one automatic feed unit and/or at least one automatic packing unit and/or at least one automatic measurement and regulation unit.

In one embodiment of the assembly and/or processing machine, the at least one transport device comprises at least one conveyor belt which is designed for transporting the at least one component in a horizontal plane into the working chamber and out of the working chamber in a transport direction. In this way, automatic loading and unloading of the assembly and/or processing machine is made possible, and the linking-together thereof in the transport direction of the component is assisted.

Here, one and the same assembly and/or processing machine allows transport through it in particular both from the right to the left and in the opposite direction. This is advantageous in particular if multiple assembly and/or processing machines are arranged with their operating and display units pointing toward one another in parallel production lines, because the same material flow direction is possible in the production lines.

Here, the movable part of the protective housing is preferably displaceable together with the operating and display unit parallel to a longitudinal axis of the conveyor belt. This means that the space in front of the assembly and/or processing machine is kept free at all times, and means that said space can at all times be utilized for operating personnel and forklift truck traffic.

The operating and display unit is preferably arranged at the height of the working chamber. Here, in particular, an arrangement is selected in which an operating person standing in front of the assembly and/or processing machine can comfortably read and operate the operating and display unit. For this purpose, an arrangement of the operating and display unit (in relation to the center thereof) at a height in the range from approximately 1.5 to 1.7 m, in particular in the region of 1.6 m, has proven expedient.

For a production line comprising at least two linked-together assembly and/or processing machines according to the disclosure, the object is furthermore achieved in that the operating and display units of the linked-together assembly and/or processing machines are arranged in a vertical plane, in that a first transport device of a first assembly and/or processing machine comprises a first conveyor belt, in that a second transport device of a second assembly and/or processing machine comprises a second conveyor belt, and in that the first conveyor belt and the second conveyor belt join one another and are designed for transporting the at least one component in a horizontal plane.

The uniform orientation of the operating and display units of all of the assembly and/or processing machines, and the direct transfer, by conveyor belts, of the component for processing from one assembly and/or processing machine to the next assembly and/or processing machine which is linked together therewith, makes it possible to realize a production line with an extremely small space requirement and, at the same time, particularly straightforward operability even by a single operating person. In this way, the throughput time of the component through the production line, and also the costs for the operating personnel, are minimized. Furthermore, the investment costs for the linking-together process itself are reduced. Fault elimination in a production line constructed in this way is simplified, and the technical availability of said production line is significantly increased.

Furthermore, for a production installation comprising at least two production lines according to the disclosure and at least one operating aisle, the object is achieved in that in each case one production line is arranged on each side of each operating aisle, wherein first operating and display units, arranged in a vertical first plane, of a first production line and further operating and display units, arranged in a vertical further plane, of a second production line are arranged so as to point toward one another.

By such an arrangement of the production lines, a further reduction in personnel costs can be achieved, because a single operating person in one operating aisle can simultaneously monitor two production lines. Here, an “operating aisle” is to be understood to mean an elongate free space or walkway or travel path between the production lines.

Here, each operating aisle preferably has a width in the range from 0.75 to 1.5 m, in particular of 1.2 m. Here, the width denotes the spacing between the two mutually oppositely situated production lines.

### BRIEF DESCRIPTION OF THE DRAWINGS

FIGS. 1 to 5 are intended to illustrate, by way of examples, assembly and/or processing machines according to the disclosure and production lines and production installations formed from such machines. In the figures:

FIG. 1 shows a first assembly and/or processing machine according to the disclosure with a closed protective housing;

FIG. 2 shows the first assembly and/or processing machine according to the disclosure as per FIG. 1 with an open protective housing;

FIG. 3 shows a second assembly and/or processing machine according to the disclosure with a closed protective housing;

FIG. 4 shows a production line comprising three assembly and/or processing machines as per FIG. 3; and

FIG. 5 shows a production installation comprising two production lines as per FIG. 4.

### DETAILED DESCRIPTION

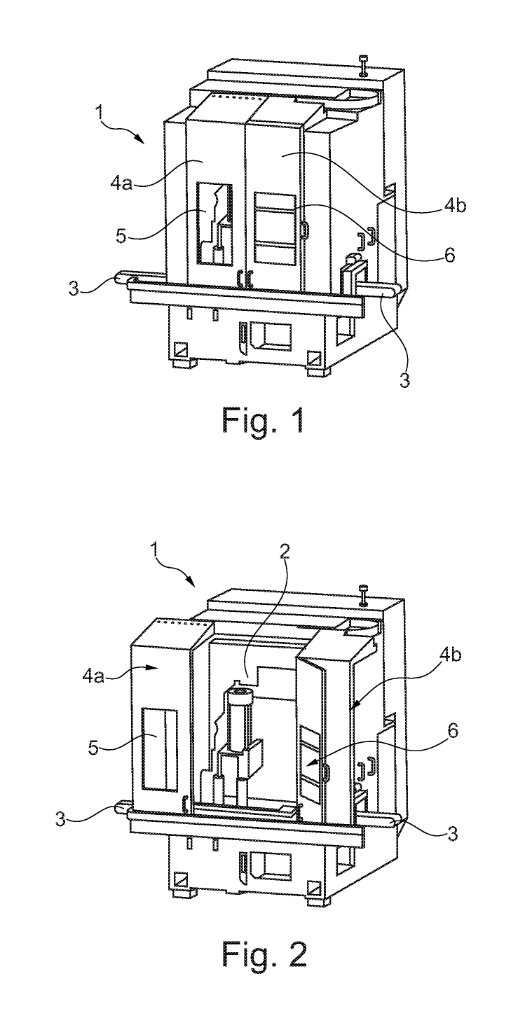

FIG. 1 shows a first assembly and/or processing machine 1 according to the disclosure with a closed protective housing 4a, 4b in a three-dimensional view. The assembly and/or processing machine 1 comprises a working chamber 2 (see FIG. 2) for the assembly and/or processing of components which are transported into the working chamber 2 by a transport device 3 in the form of a conveyor belt. Here, it is possible for the components to be transported through the assembly and/or processing machine 1 from right to left or from left to right. The assembly and/or processing machine 1 furthermore comprises a two-part movable protective housing 4a, 4b for temporarily shielding the working chamber 2 during the assembly and/or processing of the components in the working chamber 2. Here, both parts of the protective housing 4a, 4b are designed to be movable, wherein the two parts are displaceable parallel to the conveyor belt and possibly also pivotable to a small extent.

The protective housing 4a, 4b comprises a viewing window 5 which, when the protective housing 4a, 4b is closed, makes it possible to observe the assembly and/or processing of the components in the working chamber 2. Furthermore, an operating and display unit 6 is provided which is arranged on one of the movable parts of the protective housing 4a, 4b and is movable together therewith.

FIG. 2 now shows the first assembly and/or processing machine according to the disclosure as per FIG. 1 with an open protective housing 4a, 4b in a three-dimensional view. Identical elements are denoted by the same reference designations as in FIG. 1. As a result of the parts of the protective housing 4a, 4b having been displaced to the side, there is in this case a clear view into the working chamber 2 and of the transport device 3 which extends transversely through the working chamber 2. Here, the two movable parts of the protective housing 4a, 4b are moved away from one another during the opening process and are moved toward one another during the closing process. The operating and display unit 6 is fully functional both when the protective housing 4a, 4b is closed and when the latter is open, furthermore even during the opening and closing of the protective housing 4a, 4b.

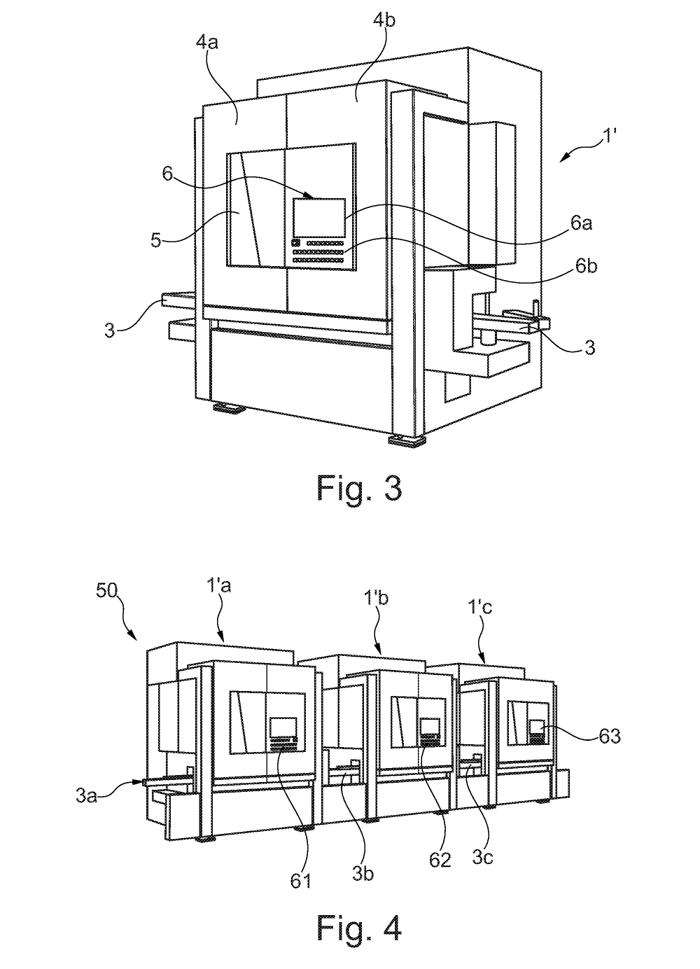

FIG. 3 shows a second assembly and/or processing machine 1′ according to the disclosure with a closed protective housing 4a, 4b. The parts of the protective housing 4a, 4b are displaceable parallel to the longitudinal axis of the conveyor belt of the transport device 3 in order to open or close the working chamber 2 (cf. FIG. 2). Identical elements are denoted by the same reference designations as in FIGS. 1 and 2. The operating and display unit 6 is illustrated here in detail, wherein a display unit 6a and an operating unit 6b in the form of a keyboard element can be seen. Alternatively, it is also possible for a touchscreen unit to be provided which combines within it the display unit and operating unit.

FIG. 4 shows a production line 50 comprising three linked-together assembly and/or processing machines 1′a, 1′b, 1′c as per FIG. 3 in a three-dimensional view. The operating and display units 61, 62, 63 of the linked-together assembly and/or processing machines 1′a, 1′b, 1′c are in this case arranged in a vertical plane. A first transport device 3a of a first assembly and/or processing machine 1′a comprises a first conveyor belt. A second transport device 3b of a second assembly and/or processing machine 1′b comprises a second conveyor belt. A third transport device 3c of a third assembly and/or processing machine 1′c comprises a third conveyor belt. The first, the second and the third conveyor belt join one another and are designed for transporting the component for processing in a horizontal plane through the production line.

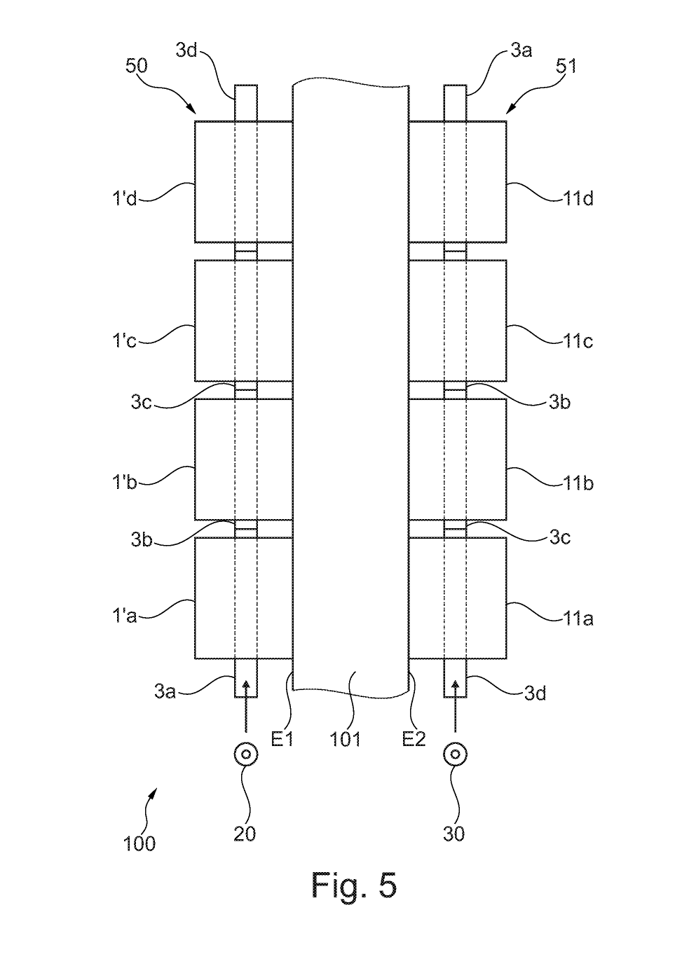

FIG. 5 is a schematic illustration of a production installation 100 comprising two production lines 50, 51 in a plan view. Identical elements are denoted by the same reference designations as in FIG. 4. The two production lines 50, 51 are arranged on the left and on the right along an operating aisle 101. The operating and display units 61, 62, 63 etc. of the first production line 50 are arranged in a vertical first plane E1 (cf. FIG. 4). The operating and display units 61, 62, 63 etc. of the second production line 51 are arranged in a vertical further plane E2 (cf. again FIG. 4). Here, the operating and display units 61, 62, 63 etc. of the two production lines 50, 51 are arranged so as to point toward one another. A person situated in the operating aisle 101 can simultaneously monitor both production lines 50, 51 and, if necessary, intervene in the control thereof by the operating and display units 61, 62, 63 etc. Also illustrated here by way of example are components 20, 30 for processing, in the form of rolling bearing rings, which are transported in the arrow direction through the respective production line 50, 51. Here, it is for example the case that the assembly and/or processing machine 1′a, 11a is a vertical grinding machine, the assembly and/or processing machine 1′b, 11b is a demagnetization unit, the assembly and/or processing machine 1′c, 11c is a washing unit and the assembly and/or processing machine 1′d, 11d is a vertical honing machine, to which the components 20, 30 are fed for processing in succession.

Here, it is possible for any desired number of assembly and/or processing machines to be linked together and for different and/or identical assembly and/or processing machines to be provided in a single production line. Also, it is not necessary for both production lines which can be operated from the operating aisle to be of identical form as viewed in the transport direction of the components, or for identical or similar components to be processed by the two production lines. If multiple operating aisles are provided, these are preferably oriented parallel, wherein, for example, two production installations as per FIG. 5 are arranged adjacent to one another. Here, those sides of the assembly and/or processing machines which are averted from the operating aisle 101 would in each case preferably adjoin those sides of assembly and/or processing machines assigned to said further operating aisle which are averted from the further parallel operating aisle.

### LIST OF REFERENCE DESIGNATIONS

1, 1′, 1′a, 1′b, 1′c, 1′d,
11a, 11b, 11c, 11d Assembly and/or processing machine
2 Working chamber
3, 3a, 3b, 3c, 3d Transport device
4a, 4b Protective housing
5 Viewing window
6, 61, 62, 63 Operating and display unit
6a Display unit
6b Operating unit
20, 30 Component
50, 51 Production line
100 Production installation
101 Operating aisle

1. An assembly and/or processing machine comprising:
a working chamber for the assembly and/or processing of at least one component,
at least one transport device for transporting the at least one component into the working chamber,
a protective housing which is at least partially movable and which temporarily shields the working chamber during the assembly and/or processing of the at least one component in the working chamber, wherein the protective housing includes at least one viewing window which, when the protective housing is closed, allows observation of the assembly and/or processing of the at least one component in the working chamber, and
at least one operating and display unit,
wherein the at least one operating and display unit is arranged on a movable part of the protective housing and is movable together therewith.

2. The assembly and/or processing machine as claimed in claim 1, wherein the at least one operating and display unit is functional both when the protective housing is closed and when the protective housing is open.

3. The assembly and/or processing machine as claimed in claim 1, wherein the movable part of the protective housing is pivotable and/or displaceable.

4. The assembly and/or processing machine as claimed in claim 1, wherein the processing machine is designed to perform deformation, cutting, joining, coating, or material alteration on the at least one component.

5. The assembly and/or processing machine as claimed in claim 1, wherein the processing machine includes at least one of the following units: a grinding machine, a honing machine, a milling machine, a turning machine, a lapping machine, a drilling machine, a punching unit, a press unit, a heat treatment unit, a cleaning unit, a drying unit, a demagnetization unit, an automatic measurement and regulation unit, an automatic feed unit, or an automatic packing unit.

6. The assembly and/or processing machine as claimed in claim 1, wherein the at least one transport device includes at least one conveyor belt which is configured to transport the at least one component in a horizontal plane into the working chamber and out of the working chamber in a transport direction.

7. The assembly and/or processing machine as claimed in claim 6, wherein the movable part of the protective housing is displaceable together with the operating and display unit parallel to a longitudinal axis of the conveyor belt.

8. The assembly and/or processing machine as claimed in claim 1, wherein the operating and display unit is arranged at a height of the working chamber.

9. A production line comprising at least two linked-together assembly and/or processing machines as claimed in claim 1, wherein the operating and display units of the linked-together assembly and/or processing machines are arranged in a vertical plane, a first transport device of a first assembly and/or processing machine includes a first conveyor belt, a second transport device of a second assembly and/or processing machine includes a second conveyor belt, and the first conveyor belt and the second conveyor belt join one another and are configured to transport the at least one component in a horizontal plane.

10. A production installation comprising at least two production lines as claimed in claim 9 and at least one operating aisle, wherein in each case one production line is arranged on each side of each operating aisle, and wherein first operating and display units, arranged in a vertical first plane, of a first production line and further operating and display units, arranged in a vertical further plane, of a second production line are arranged so as to point toward one another.

11. The production installation as claimed in claim 10, wherein each operating aisle has a width in a range from 0.75 to 1.5 m.

12. A machine comprising:
a working chamber for assembling and/or processing of a component;
a transport device configured to transport the component into the working chamber;
a moveable housing which is configured to temporarily shield the working chamber during the assembly and/or processing of the component in the working chamber, wherein the housing includes a viewing window which, when the housing is closed, allows observation of the assembly and/or processing of the component in the working chamber; and
an operating and display unit arranged on a movable part of the housing and is movable together therewith.

13. The machine as claimed in claim 12, wherein the operating and display unit is functional both when the housing is closed and when the housing is open.

14. The machine as claimed in claim 12, wherein the movable part of the housing is pivotable and/or displaceable.

15. The machine as claimed in claim 12, wherein the machine is designed to perform deformation, cutting, joining, coating, or material alteration on the component.

16. The machine as claimed in claim 12, wherein the machine includes at least one of the following units: a grinding machine, a honing machine, a milling machine, a turning machine, a lapping machine, a drilling machine, a punching unit, a press unit, a heat treatment unit, a cleaning unit, a drying unit, a demagnetization unit, an automatic measurement and regulation unit, an automatic feed unit, or an automatic packing unit.

17. The machine as claimed in claim 12, wherein the transport device includes at least one conveyor belt which is configured to transport the component in a horizontal plane into the working chamber and out of the working chamber in a transport direction.

18. The machine as claimed in claim 17, wherein the movable part of the housing is displaceable together with the operating and display unit parallel to a longitudinal axis of the conveyor belt.

19. The machine as claimed in claim 12, wherein the operating and display unit is arranged at a height of the working chamber.
